(19) United States
(12) Patent Application Publication
(10) Pub. No.: US 2018/0208163 A1
(43) Pub. Date: Jul. 26, 2018

(54) BRAKE PEDAL ASSEMBLY WITH PEDAL PAD FORCE SENSORS

(71) Applicants: Joong K. Lee, Chatham (CA); Dan O'Neill, Chatham (CA)

(72) Inventors: Joong K. Lee, Chatham (CA); Dan O'Neill, Chatham (CA)

(21) Appl. No.: 15/876,830

(22) Filed: Jan. 22, 2018

Related U.S. Application Data
(60) Provisional application No. 62/448,502, filed on Jan. 20, 2017.

(51) Int. Cl. B60T 7/04; B60T 13/74

(52) U.S. Cl. CPC B60T 7/042; B60T 17/221; B60T 13/746

(57) ABSTRACT

The invention relates to a pedal pad force sensing assembly having a force sensing capacitor. The force sensing capacitor includes an upper plate which is overmolded into the pad body and a lower plate supported on the pedal arm. A sensing module includes an electronic circuitry to determine change of capacitance when pressure is placed on an upper surface of the pad. The sensing assembly may advantageously include a reference capacitor which is mounted near the sensing capacitor but not subjected to pressure.

### CROSS REFERENCE TO RELATED APPLICATIONS

This application claims priority of U.S. Provisional Application 62/448,502 filed Jan. 20, 2017.

### FIELD OF THE INVENTION

This application relates to brake pedal assemblies, particularly brake pedal assembly with a pedal pad having a pressure sensor.

### BACKGROUND OF THE INVENTION

Fly-by-wire brake pedal assemblies for vehicles are well known. A pedal arm is pivotally mounted to a bracket about a pivot point. A position sensor, such as a non contacting position sensor, is mounted along the position on the axis of the pivot point to measure the angular rotation of the pedal arm during depression. Mechanical devices such as springs and cam surfaces are connected to the pedal arm to generate a hysteresis during depression of the pedal. The hysteresis simulates the feel of the depression of a mechanical pedal assembly. However it is possible that depression of the pedal arm can be blocked by an object contacting the pedal arm. In such a situation, it would be useful to identify such a condition and perhaps implement an automatic braking system. Thus, it would be desirable to have a fly-by-wire vehicle pedal assembly which measures the force put on the pedal during depression and compare the force with movement of the pedal arm.

### SUMMARY OF THE INVENTION

The invention relates to a pedal pad force sensing assembly having a force sensing capacitor. The force sensing capacitor includes an upper plate which is overmolded into the pad body and a lower plate supported on the pedal arm. A sensing module includes an electronic circuitry to determine change of capacitance when pressure is placed on an upper surface of the pad. The sensing assembly may advantageously include a reference capacitor which is mounted near the sensing capacitor but not subjected to pressure. The reference capacitor has generally equal capacitance to that of the sensing capacitor when there is no pressure on the sensing capacitor. An additional feature of the assembly is use of the pedal arm to deliver signals between the lower plate of the capacitors and the sensing module.

### DESCRIPTION OF THE DRAWINGS

FIG. 1 is a perspective view of a brake pedal assembly having a pedal pad with pressure sensing capacitor in accordance with the invention.

FIG. 2. is a cross-sectional view of the bracket for the pedal assembly in accordance with the invention.

FIG. 3A is a cross-sectional view of pedal pad with a pressure sensing capacitor and reference capacitor in accordance with the invention.

FIG. 3B is a top view of the pedal pad taken along lines 3A-3A.

FIG. 4A is a side cross sectional view of an additional embodiment.

FIG. 4B is a cross-sectional view of the arrangement of sensor capacitor and reference capacitor taken along lines 4A-4A.

FIG. 5 is a schematic view of the sensing assembly; and

FIG. 6 is a side view of the pedal arm in accordance with the invention.

### DETAILED DESCRIPTION OF THE INVENTION

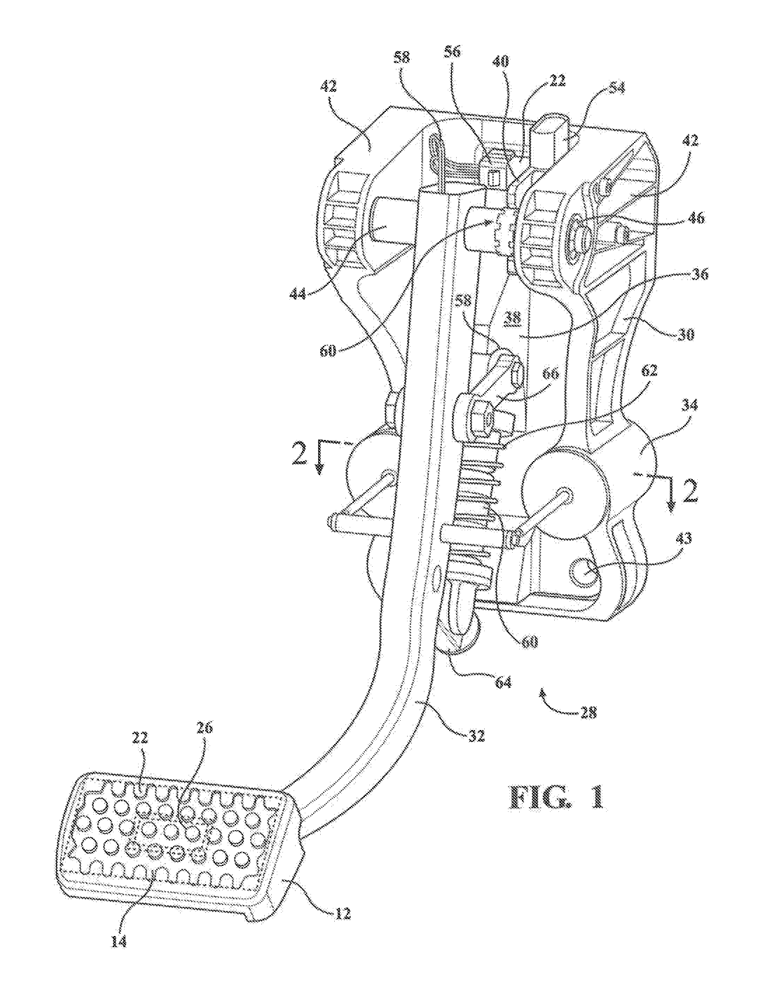

As shown in FIGS. 1-3A, 3B, and 5, a pedal force sensor assembly 100 includes a pedal pad 10 having an elastomeric body 12. The pad 10 has a pressure sensing capacitor 20 formed by an upper plate 14 spaced apart from a lower plate 16 by a portion of the body 12 which acts as a dielectric. The plates 14, 16 are electrically connected to an electronic module 22. Pressure on an outer surface 24 of the pad 10 compresses the body and moves the plates 14, 16 closer together to change the capacitance. The electronic module 22 determines the amount of change in capacitance and calculates force corresponding to the pressure placed on the pedal pad 10 by user. The force sensor assembly 100 includes a reference capacitor 26 which is used for correcting for changes in elastomeric body which result from temperature change, age or “creep”.

As shown in FIG. 1, the pedal force sensor assembly 100 is particularly adapted for a fly-by-wire vehicle brake pedal assembly 28 in order to determine whether the pedal arm has been blocked from operation. If so, a brake assist can be activated. However, the pedal force sensor can be used in other applications which require monitoring of the pressure applied to the pedal.

The brake pedal assembly 28 includes a bracket 30 pivotally supporting a pedal arm 32 which is connected to a pair of air damping dashpots 24, and a hysteresis assembly 36. The brake assembly 28 also includes an electronic module 38.

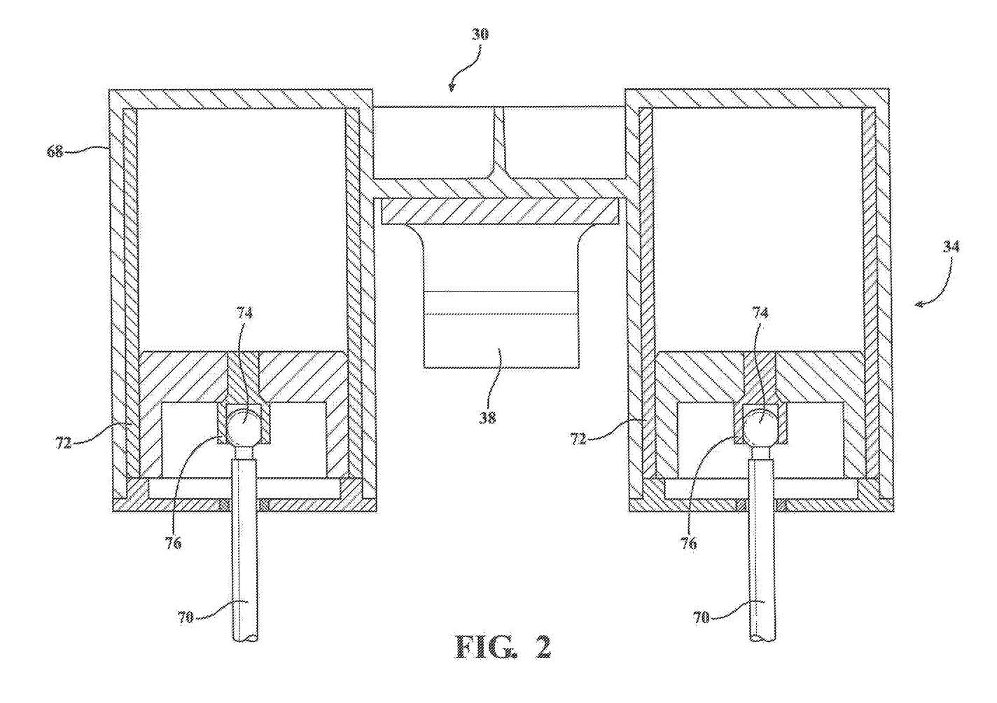

As shown in FIGS. 1 and 2, the bracket 30 is formed of a molded material and has an upper portion having a pair of arms 42 for supporting a pivot pin 44. The pair of dashpots 34 are spaced apart near a lower end of the bracket 30. The bracket 30 also includes apertures 43 for fasteners (not shown) for mounting the bracket 30 to the vehicle. The bracket can be provided with an electrically conductive path through to the chassis through the fasteners to provide a ground for the sensing system.

The pedal arm 32 may be formed of any suitable rigid material. In the preferred embodiment, the pedal arm 32 is formed as a metal box. The pedal arm 32 is supported at an upper end by the pivot pin 44 and bushings. A bush nut 46 is mounted on one end of the pivot pin to prevent dislodgment of the pin 44. The pedal pad 10 is mounted to a lower end of the pedal arm 32.

A rotational position sensor assembly 50 mounted to the bracket near or along the pivot axis of the pedal arm 32. The position sensor may be of any suitable type such as an inductive arc to linear sensor. The sensor assembly 50 includes a housing 52 containing a PCB with election circuitry for determining the rotation of the pedal arm 32. The housing 52 may also include pressure sensor module 22 with the circuitry for the pressure sensor assembly 100. The housing 52 has a connector 54 for connecting sensor assemblies to a bus carrying information to vehicle control systems. A second connector 56 is provided for connection to a wire harness 58 communicating signals between the capacitive pressure sensor 20 and reference sensor 26 of the pedal pad and the pressure sensor assembly module 22.

As shown in FIG. 1, the hysteresis generating assembly 34 includes a cam member 38 which is mounted to the bracket 30 and a cam roller 58 is supported beneath the pedal arm 32 by a telescoping spring-biased rod 60. The cam member 38 has a curved cam surface. The surface is curved to provide tactile feedback when the pedal is depressed which emulates the resistance of a mechanical pedal. The shape of the surface 58 can be a continuous curve or involve a number of curves or shapes to provide the resistance desired. The cam roller 56 is supported beneath the pedal arm on a compressible elastomeric arm 60 and a biasing spring 62 which extends about the elastomeric arm 60. One end of the arm is mounted to the cam roller 58 and the other end is mounted to a leg 64 which is mounted to the pedal arm. A pair of links 66 extend between the pedal arm 32 and the roller 58. The links 66 guide the roller 58 as the compressible arm 60 is compressed as the pedal is depressed and the roller travels along the cam surface 58.

As shown in FIGS. 1 and 2, a pair of cylinders 68 are located on either side of the pedal arm 32 for dashpot assemblies 34 to provide an air dampening to the return of the pedal arm 32. A pair of rods 70 are mounted to the pedal to extend from each side of the pedal arm 32 to a pair of cylindrical pistons 72 which are received in the cylinders 68 in the bracket. The rods 70 have ball ends 74 received in ball cups 76 mounted to pistons. The dashpots provide little or no resistance to depression of the pedal. However, the dashpot controls the return speed of the pedal arm after depression.

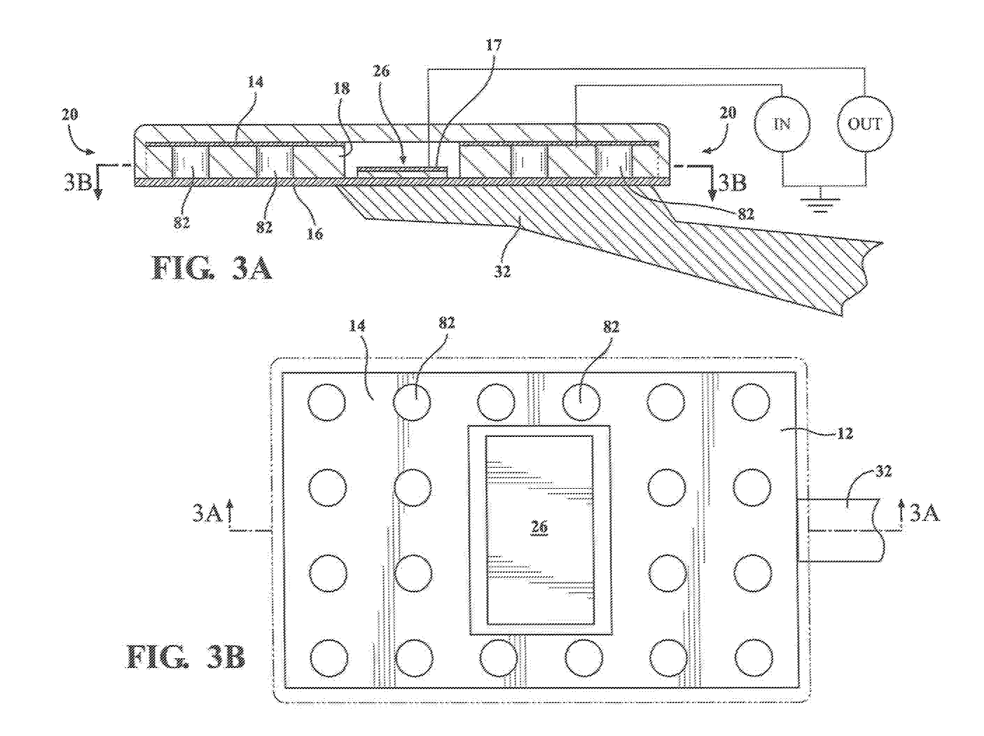

As shown in FIGS. 3A and 3B, the pedal pad force sensor assembly 100 includes the upper metal plate 14 overmolded into the pad body 12 and spaced apart from the lower metal plate 16. The lower plate extends under the pad body 12 to support the pad on the pedal arm. The pad body 12 is formed of an elastomeric material such as silicone rubber. The pad body 12 acts is a dielectric between the plates 14, 16, so as to form the pressure sensor capacitor 20. Pressure on the outer surface 24 of the pedal pad by the user compresses the capacitor of the pad body 12 between the plates slightly to change the capacitance of the sensor capacitor 20. The change of capacitance can then be correlated with the amount of force placed on the pad 10 by the sensor circuitry in the module 22. The elastomeric pad body 12 is secured mechanically or by adhesive to the lower plate 16.

Capacitive sensors may be subject to “drift” caused by mechanical or chemical changes of the capacitor material which occurs through aging, environmental impact and material creep. In order to minimize the effects, the reference capacitor 26 may be used. The reference capacitor 26 has equal capacitance to the sensing capacitor 20 before depression. The reference capacitor 26 is located near the pressure sensing capacitor 20 in location where the capacitance is not subject to pressure.

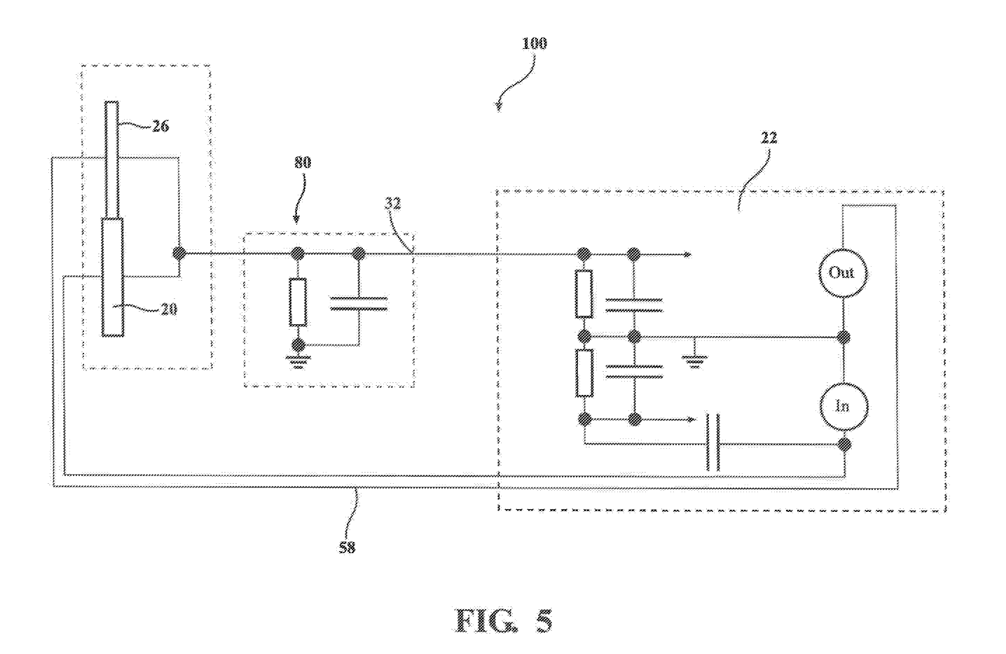

A preferred embodiment of the reference capacitor 26 is shown in FIGS. 3A and 3B. The reference capacitor 26 is positioned on the lower plate 16 in a center void in the center of the pad body 12. This reference sensor 26 position is not impacted or pressed when pressure is placed on the outer surface 24 of the pad body 12. The reference capacitor 26 uses the same lower plate 16 as the sensing capacitor 20 but has a separate dielectric and upper plate 17. As shown in FIG. 5, output from the sensing capacitor 20 is delivered to the sensing module by wire and the output from the reference capacitor 20 delivered through a second wire. The lower plate is electrically connected through the pedal arm 32 to the control sensor module 22. The electrical nature 80 of the pedal arm 32 is shown as a combination of a resistor and capacitor pair (the impedance of a pedal) which represents the electrical impedance that is a combination of the capacitive and the resistant links to the vehicle chassis. The capacitance of the pedal arm should not be greater than 2 pF and the resistance of the arm should not be greater than 300 k.

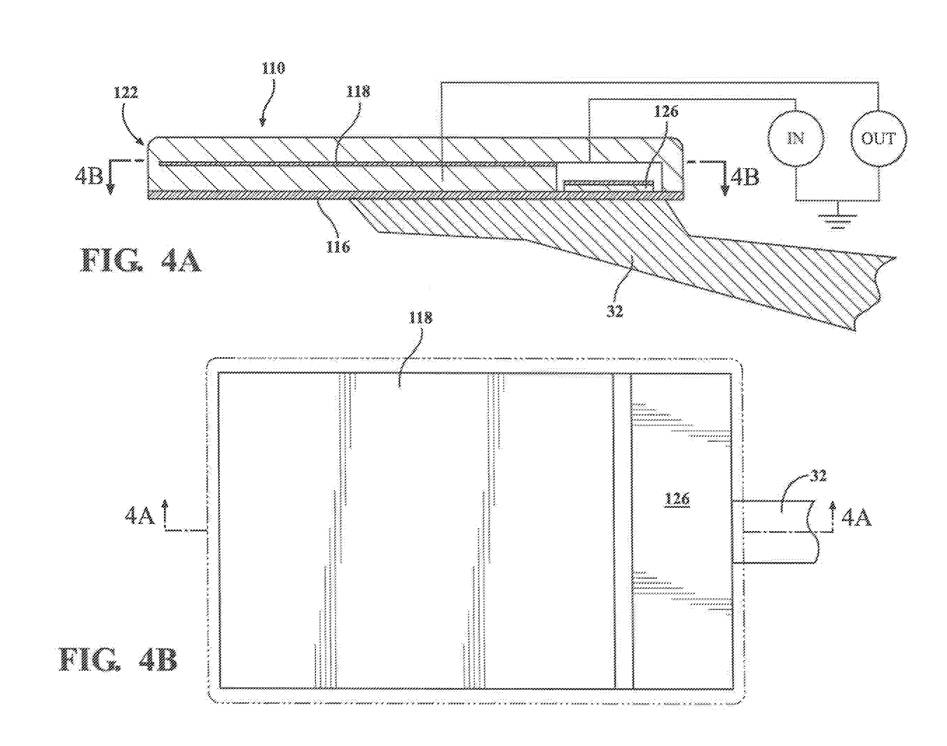

An alternative embodiment of a reference capacitor 13 is shown in FIGS. 4A and 4B. The reference capacitor 126, alternatively may be located off to the side of the pedal pad 110 in a position where it is not impacted or pressed when a pressure sensor capacitor 120 is subjected to force. The pedal pad 110 has an upper plate 114 and a lower plate 116. The reference capacitor 126 and uses the same lower plate 116 as the sensing capacitor but has a separate dielectric and upper plate 117.

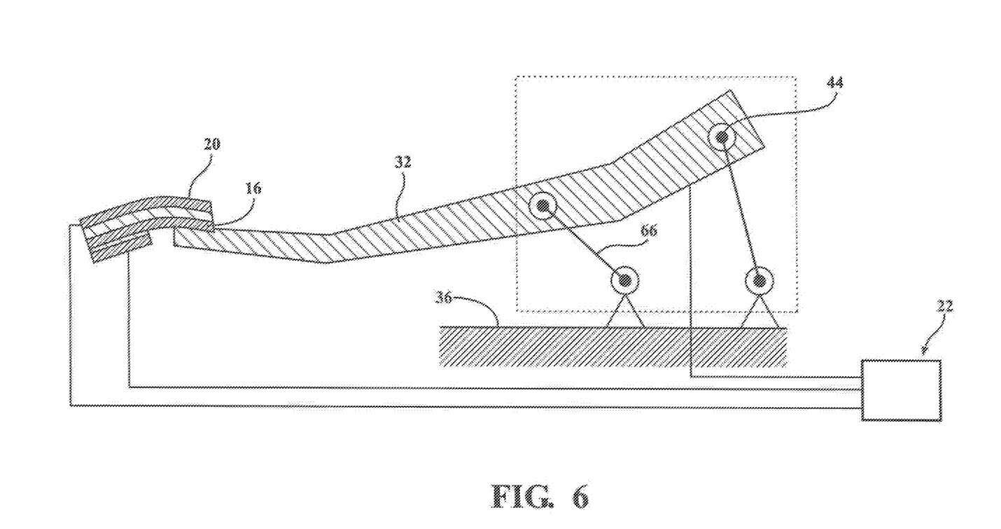

As shown in FIG. 6, if the pedal arm is used as the output wire, the links to the chassis need to be minimized with respect to resistance and capacitance to conserve electrical signal. If the pedal arm is not being used as a wire, it is necessary to isolate the lower plate 16 from the arm.

In order to measure the force level regardless of electric properties of the elastomer or pad body, the amount of charge on the sensing capacitor 20 and reference capacitor 26 should be equal. The capacitance can be balanced by varying the ratio area of a pressure sensor area to area of the reference sensor and the ratio of the distance between the plates.

When the voltage sources are equal, the force can be expressed as a ratio:

$$Rx = \frac{Fm}{Bm}$$

BM is the Base Module
FM is the Force Module

It would also be possible to provide creep compensation by applying the spring force to the reference capacitor. A preloaded spring is applied to the reference capacitor. The spring force is applied as a creep generating force to the top of the reference capacitor plate. The spring places a force that is proportional to the constant creep generating force. The force is assumed to be an average force such as the weighted average of loading cycles. Force can be quantified by experiment with respect to the loading history in the pad material. The ECU of the vehicle will have the loading history and time record of the loading that is necessary that can be used for the creep tracking need to be minimized with respect to resistance and capacitance to conserve electrical signal.

In order to provide a higher gain of signal it is desired to lower the value of the spring constant K of the dielectric pad body. This can be done by providing an array of holes of the dielectric pad body as shown in Fig. A and FIG. 3B. The ratio of the whole area to the solid area is proportional to the spring constant. In order to get a higher gain of signal, the spring constant K should be low. The ratio of the hole solid area is proportional to the spring constant due to the irrepressibility nature of the elastomer. The effective area of the corresponding capacitance should be adjusted with respect to the dielectric constant of the given material.

Thus disclosed is a novel brake pedal assembly having a pedal pad pressure sensor and air cylinders acting as dashpots to air dampen the return of the pedal. The pressure sensors provide a warning that pressure is being put on the pad but the pedal travel is blocked, for instance by an obstruction behind the pedal arm. It will be apparent to those skilled in the art that other variations and modifications of what is detailed herein are within the scope of the invention.

1. A pedal force sensing assembly for sensing pressure on a pedal pad, the sensing assembly.
comprising:
a pedal arm;
a pad body supported on the pedal arm, the pad body having a force sensing capacitor, the force capacitor having an upper plate and a lower plate, a sensing module electrically connected to each of sensor capacitor, the sensing module adapted to determine pressure on the pad by sensing a change of capacitance of the pressure sensing capacitor occurring when force is applied to the pedal pad.

2. The sensing assembly of claim 1 further comprises:
a reference capacitor.

3. The sensing assembly of claim 1 wherein the lower plate is mounted to an end of the pedal arm.

4. The sensing assembly of claim 1 wherein the upper conductive plate is over molded in the pad body.

5. The sensor assembly of claim 1 wherein the pad body is formed of an elastomer.

6. The sensing assembly of claim 2, wherein the reference capacitor has generally the same capacitance as the force sensing capacitor when not subject to pressure.

7. The sensing assembly of claim 2, wherein the pad body has a center void and the reference capacitor is positioned within the center void.

8. The sensing assembly of claim 2 wherein the reference capacitor is formed with a portion of the lower plate

9. The sensing assembly of claim 1, wherein the pedal arm conducts an electrical signal between the lower plate and the sensor module.

10. The sensing assembly of claim 1, wherein the sensing module includes a housing mounted to the bracket and electronic circuitry.

11. The sensing assembly of claim 2, wherein the serving module is adapted to capacitance.

12. A pedal assembly comprising:
a bracket;
a pedal arm pivotally mounted to the bracket;
at least one dashpot having a rod connected to the pedal arm to control return of the pedal arm after depression.

13. The pedal assembly of claim 12 comprising a position sensor to determine a rotational position of the arm.

14. The pedal assembly of claim 13 further comprising a hysteresis assembly.
